(19) United States
(12) Patent Application Publication
(10) Pub. No.: US 2007/0247514 A1
(43) Pub. Date: Oct. 25, 2007

(54) Automatic laser power uniformity calibration

(76) Inventors: Ran Waidman, Rehovot (IL); Shlomo Harush, Rehovot (IL); Gregory Braverman, Rehovot (IL); Maya Shalev, Rehovot (IL); Eyal Shelef, Rehovot (IL); Michael Plotkin, Rehovot (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/412,008

(22) Filed: Apr. 25, 2006

(51) Int. Cl. B41J 2/435

(52) U.S. Cl. 347/236

(57) ABSTRACT

This invention relates to a method of laser power uniformity calibration, comprising: printing a first pattern by a first laser beam; moving the first laser beam to print a second pattern such that the second pattern is located at a predetermined distance from the first pattern; printing the first and second patterns by a second laser beam; comparing the first and second patterns printed by the first and second laser beams; and optionally adjusting a power in the first and second laser beams.

### BACKGROUND OF THE INVENTION

1. Field of the Invention

This invention relates to a method of laser power uniformity calibration, comprising: printing a first pattern by a first laser beam; moving the first laser beam to print a second pattern such that the second pattern is located at a predetermined distance from the first pattern; printing the first and second patterns by a second laser beam; comparing the first and second patterns printed by the first and second laser beams; and optionally adjusting a power in the first and second laser beams.

2. Description of the Related Art

Prior to the present invention, as set forth in general terms above and more specifically below, it is known, in laser power uniformity calibration systems to print special patterns using one of 12 (1 on, 11 off) lasers for each pattern. As shown in FIG. 1, the patterns 2 are arranged diagonally for better visualization of the patterns' differences. If the power between adjacent lasers is different, ideally this should be shown in FIG. 1 by varying degrees of lightness/darkness or optical density (OD) in adjacent patterns. Optical density (OD) is the absorbance of an optical element for a given wavelength per unit distance. If varying degrees of OD in adjacent patterns is observed by the operator that the operator can change the power in the laser in order to create laser power uniformity among all of the lasers. The disadvantages of this laser power uniformity calibration system are that the operator can only compare each pattern to its two neighbors and might miss some defects in other lasers. Also, different operators have different abilities to see the visual effects. Finally, the ability to estimate the needed laser power changes is difficult because it is done by an iterative process which causes an increased expenditure of consumables and time. Consequently, a more advantageous system, then, would be provided if this type of diagonal pattern comparison technique, along with the laser power change iterative process, could be eliminated.

It is also known, in laser power uniformity calibration systems to perform automatic calibrations of the laser power uniformity by using an in-line densitometer (ILD). As shown in FIG. 2, the pattern 20 is printed using only one of 12 lasers (1 on and 11 off). The pattern is repeated for the remaining 11 lasers by turning one of the lasers on and turning the other 11 off in succession. The disadvantage of this laser power uniformity calibration system is that the accuracy of the ILD is not sufficient to detect differences in these bright patterns. Therefore, a further advantageous laser power uniformity calibration system, then, would be provided if this type of pattern could also be avoided.

It is apparent from the above that there exists a need in the art for a laser power uniformity calibration system that avoids the use of the prior art patterns and the laser power change iterative process. It is a purpose of this invention to fulfill this and other needs in the art in a manner more apparent to the skilled artisan once given the following disclosure.

### SUMMARY OF THE INVENTION

Generally speaking, an embodiment of this invention fulfills these needs by providing a method of laser power uniformity calibration, comprising: printing a first pattern by a first laser beam; moving the first laser beam to print a second pattern such that the second pattern is located at a predetermined distance from the first pattern; printing the first and second patterns by a second laser beam; comparing the first and second patterns printed by the first and second laser beams; and optionally adjusting a power in the first and second laser beams.

In certain preferred embodiments, the first and second laser beams are moved through the use of a dynamic mirror shift. Also, the first and second patterns printed by the first and second laser beams are compared through the use of an in-line densitometer (ILD). Finally, a third and subsequent patterns can be printed by the first and second laser beams in order to provide a greater laser power uniformity calibration.

In another further preferred embodiment, the printing of identical first and second patterns by the different laser beams, along with the use of the ILD, creates an automatic laser power uniformity calibration that reduces calibration adjustment time and improves print quality

The preferred laser power uniformity calibration system, according to various embodiments of the present invention, offers the following advantages: ease-of-use; simplified manual adjustment operation; reduced calibration adjustment time; improved print quality; improved ILD measurement abilities; and extended writing head life. In fact, in many of the preferred embodiments, these factors of ease-of-use, simplified manual adjustment operation, reduced calibration adjustment time, improved print quality, and improved ILD measurement abilities are optimized to an extent that is considerably higher than heretofore achieved in prior, known laser power uniformity calibration systems.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a schematic illustration of a manual calibration diagram, according to prior art;

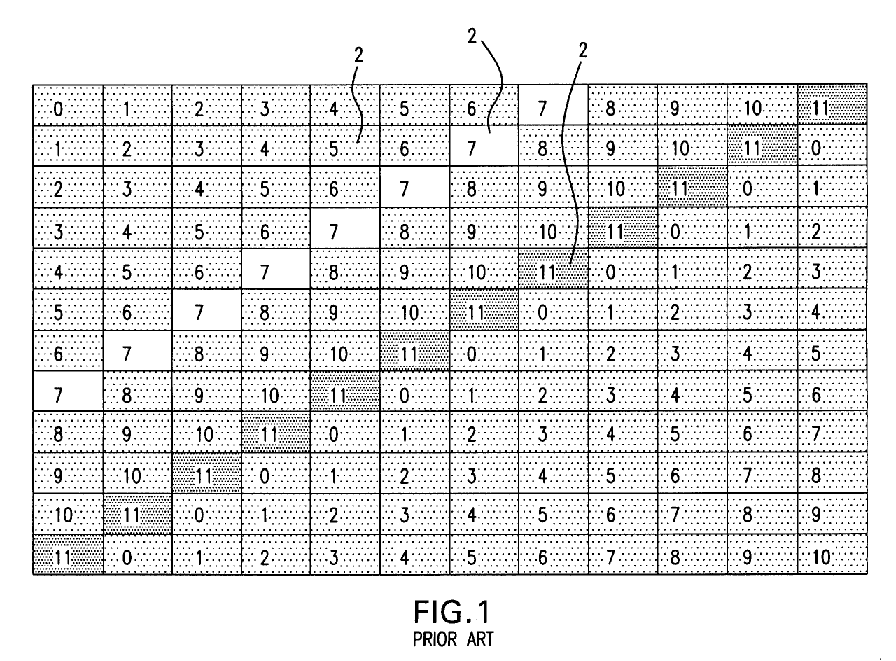

FIG. 2 is a schematic illustration of an automatic calibration diagram, according to prior art;

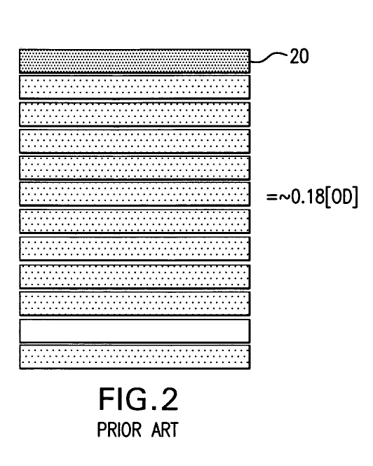

FIG. 3 is a flowchart of a method of a laser power uniformity calibration method, according to one embodiment of the present invention; and

FIG. 4 a schematic illustration of the automatic calibration diagrams, according to another embodiment of the present invention.

### DETAILED DESCRIPTION OF THE INVENTION

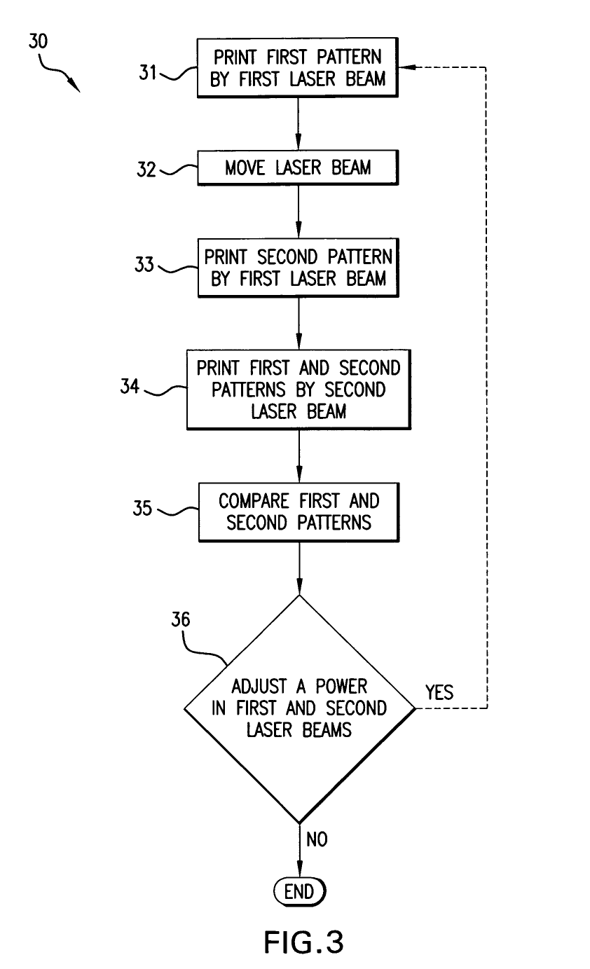

With reference to FIG. 3, there is illustrated one preferred embodiment for use of the concepts of this invention. FIG. 3 illustrates a method 30 for laser power uniformity calibration. Method 30 includes, in part, the steps of: printing a first pattern by a first laser beam (step 31); moving the laser beam (step 32); printing a second pattern by the first laser beam (step 33); printing the first and second patterns by a second laser beam (step 34); comparing the first and second patterns printed by the first and second laser beams (step 35); and optionally adjusting a power in the first and/or second laser beams (step 36).

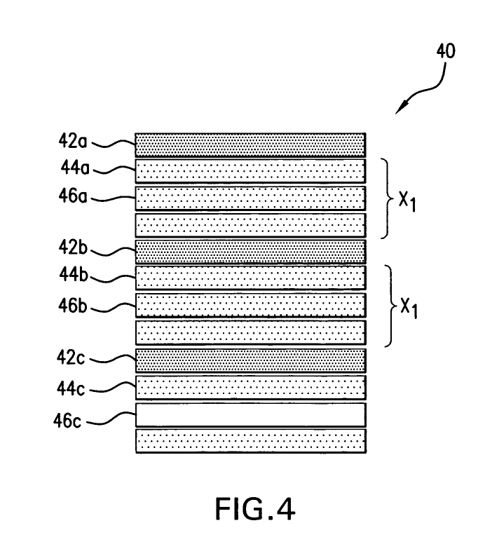

With respect to step 31, a first predetermined pattern 42a (FIG. 4) is printed using a first laser beam that is created from a first laser. It is to be understood that any other laser located within the print head is turned off except for the first laser. It is to be further understood that each of the lasers in the printing device is turned on, while the other lasers are turned off in succession in order to print the pattern that will be used to determine the laser power uniformity calibration for the entire printing device

With respect to step 32, a mirror (not shown) that is located adjacent to the first laser is dynamically shifted. When the first laser is again activated to print the second predetermined pattern 42b, the dynamic shift causes the first laser to print the second predetermined pattern 42b at a predetermined distance (x₁) away from first predetermined pattern 42a. Preferably, the distance (x₁) is only several microns. It is to be understood that a third predetermined pattern 42c can also be printed using the first laser and the first laser beam such that the third predetermined pattern 42c is located at a predetermined distance (x₁) away from second predetermined pattern 42b. It is to be further understood that multiple patterns (more than 3) may be printed by each laser. In fact the maximum pattern number is only limited by the requirement to ensure them not overlap or interact (influence) each other. It is to be further understood that the first, second, and third predetermined patterns 42a-42c should be identical in order to provide proper feedback to the in-line densitometer (ILD). A benefit of using the dynamic mirror shift is that the laser itself is not moved which eliminates possible registration errors between the patterns 42a-42c, 44a-44c, and 46a-46c. Also, the dynamic mirror shift provides an increased optical density (OD) so that the patterns can be more easily detected by the ILD.

As discussed above, with respect to step 33, second predetermined pattern 42b is then printed by the first laser.

With respect to step 34, first and second predetermined patterns 44a and 44b are printed using a second laser beam that is created from a second laser. In this manner, the second laser is turned on and all other lasers located within the print head are turned off, as discussed above. It is to be understood that a third predetermined pattern 44c can also be printed using the second laser and the second laser beam. Also, first and second predetermined patterns 44a and 44b are also located at the same predetermined distance (x₁), as patterns 42a and 42b, from each other. It is be further understood that first, second, and third predetermined patterns 44a-44c should be identical in order to provide proper feedback to the ILD. Also, first, second, and third predetermined patterns 44a-44c may be identical to first, second, and third predetermined patterns 42a-42c.

The first, second, and, possibly, the third predetermined patterns 46a-46c created by other lasers and laser beams are located within the print head to create the overall pattern 40, as discussed above. It is be understood that while only one other set of predetermined patterns 46a-46c are illustrated, many more sets of first, second, and, possibly, third predetermined patterns could be created. The point behind the at least two sets of identical patterns being created by each laser is that this will provide a big enough difference between the various sets of patterns for the ILD to properly detect a difference in optical densities between the various sets of patterns, which will be described below.

With respect to step 35, an ILD is then used to scan first, second, and, possibly, third predetermined patterns 42a-42c to obtain an optical density (OD) for those patterns. The ILD is then used to scan first, second, and, possibly, third predetermined patterns 44a-44c to obtain a second (OD) for those patterns. This process is repeated in succession for each of the sets of patterns created by each of the lasers and leaser beams. The OD of predetermined patterns 42a-42c is compared with the OD of predetermined patterns 44a-44c to determine a uniformity of laser power between the first laser that created determined patterns 42a-44c and the second laser that created predetermined patterns 44a-44c. It is to be understood that the ILD is used to scan the first, second, and, possibly, the third predetermined patterns created by all of the lasers located within the print head. In this manner, the ODs of the various predetermined patterns created by all of the lasers can be compared with one another to provide a greater accuracy with respect to the laser power uniformity determination.

With respect to step 36, if the difference in OD between predetermined patterns 42a-42c and 44a-44c is above a predetermined threshold, the power to one or both of the lasers may be automatically adjusted. It is to be understood that if the power to one or both of the lasers is adjusted, a new set of first patterns may be created by the laser(s) that was (were) adjusted. Conversely, if the difference in OD between predetermined patterns 42a-42c and 44a-44c is at or below a predetermined threshold, the power to one or both of the lasers should not be adjusted. It is to be further understood that this process is carried out, in succession, for each laser to optionally adjust each laser.

It is to be understood that the number of laser beams should not be restricted to 12. Also, all 12 of the patterns should be printed on the same page. All of the 12 patterns are printed together, every one with a different laser beam (1 on 11 off). These same patterns are printed in three separations with a mirror shift between the separations. A mirror shift is completed for all lasers together and not a mirror shift for every laser.

It is to be understood that the flowchart of FIG. 3 shows the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction-execution system, apparatus or device such as a computer/processor based system, processor-containing system or other system that can fetch the instructions from the instruction-execution system, apparatus or device, and execute the instructions contained therein. In the context of this disclosure, a “computer-readable medium” can be any means that can store, communicate, propagate or transport a program for use by or in connection with the instruction-execution system, apparatus or device. The computer-readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc. It is to be understood that the computer-readable medium could even be paper or another suitable medium upon which the program is printed, as the program can be electronically captured, via, for instance, optical scanning of the paper or other medium, then compiled, interpreted or otherwise processed in a single manner, if necessary, and then stored in a computer memory.

Those skilled in the art will understand that various embodiment of the present invention can be implemented in hardware, software, firmware or combinations thereof. Separate embodiments of the present invention can be implemented using a combination of hardware and software or firmware that is stored in memory and executed by a suitable instruction-execution system. If implemented solely in hardware, as in an alternative embodiment, the present invention can be separately implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies. In preferred embodiments, the present invention can be implemented in a combination of software and data executed and stored under the control of a computing device.

It will be well understood by one having ordinary skill in the art, after having become familiar with the teachings of the present invention, that software applications may be written in a number of programming languages now known or later developed.

Although the flowchart of FIG. 3 shows a specific order of execution, the order of execution may differ from that which is depicted. For example, the order of execution of two or more blocks may be scrambled relative to the order shown. Also, two or more blocks shown in succession in FIG. 3 may be executed concurrently or with partial concurrence. All such variations are within the scope of the present invention.

Once given the above disclosure, many other features, modifications or improvements will become apparent to the skilled artisan. Such features, modifications or improvements are, therefore, considered to be a part of this invention, the scope of which is to be determined by the following claims.

What is Claimed is:

1. A method of laser power uniformity calibration, comprising: printing a first pattern by a first laser beam;
moving the first laser beam to print a second pattern such that the second pattern is located at a predetermined distance from the first pattern; printing the first and second patterns by a second laser beam;
comparing the first and second patterns printed by the first and second laser beams; and
optionally adjusting a power in the first and second laser beams.

2. The method, as in claim 1, wherein the moving step is further comprised of:
dynamically shifting the first laser beam to print the second pattern at a predetermined distance away from first pattern.

3. The method, as in claim 2, wherein the shifting step is further comprised of:
utilizing a mirror to dynamically shift the first laser beam.

4. The method, as in claim 1, wherein the comparing step is further comprised of:
obtaining an optical density of the first and second patterns printed by the first and second laser beams; and
comparing the optical density between the first and second patterns printed by the first and second laser beams.

5. The method, as in claim 1, wherein the comparing step is further comprised of:
utilizing an in-line densitometer to compare the first and second patterns printed by the first and second laser beams.

6. The method, as in claim 1, wherein the method is further comprised of:
moving the first laser beam to print a third pattern by the first laser beam;
moving the second laser beam to print a third pattern by the second laser beam; comparing the first, second, and third patterns printed by the first and second laser beams.

7. The method, as in claim 1, wherein the printing steps are further comprised of:
printing the first and second patterns by the first and second laser beams such that the first and second patterns are substantially identical.

8. A program storage medium readable by a computer, tangibly embodying a program of instructions executable by the computer to perform method steps for a method of laser power uniformity calibration, comprising:
printing a first pattern by a first laser beam;
moving the first laser beam to print a second pattern such that the second pattern is located at a predetermined distance from the first pattern; printing the first and second patterns by a second laser beam;
comparing the first and second patterns printed by the first and second laser beams; and
optionally adjusting a power in the first and second laser beams.

9. The method, as in claim 8, wherein the moving step is further comprised of:
dynamically shifting the first laser beam to print the second pattern at a predetermined distance away from first pattern.

10. The method, as in claim 9, wherein the shifting step is further comprised of:
utilizing a mirror to dynamically shift the first laser beam.

11. The method, as in claim 8, wherein the comparing step is further comprised of:
obtaining an optical density of the first and second patterns printed by the first and second laser beams; and
comparing the optical density between the first and second patterns printed by the first and second laser beams.

12. The method, as in claim 8, wherein the comparing step is further comprised of:
utilizing an in-line densitometer to compare the first and second patterns printed by the first and second laser beams.

13. The method, as in claim 8, wherein the method is further comprised of:
moving the first laser beam to print a third pattern by the first laser beam;
moving the second laser beam to print a third pattern by the second laser beam;
comparing the first, second, and third patterns printed by the first and second laser beams.

14. The method, as in claim 8, wherein the printing steps are further comprised of:
printing the first and second patterns by the first and second laser beams such that the first and second patterns are substantially identical.

15. A laser power uniformity calibration apparatus, comprising:
a first laser that emits a first laser beam which creates a first two predetermined patterns located at a predetermined distance from each other;
a laser beam shifting means located adjacent to the first laser for creating the at least first and second two predetermined patterns;
a second laser that emits a second laser beam which is located substantially adjacent to the first laser and the laser beam shifting means which creates at least a second two predetermined patterns located at a predetermined distance from each other and from the at least first two predetermined patterns;
an optical density comparison means for scanning/comparing the at least first and second two predetermined patterns.

16. The apparatus, as in claim 15, wherein the first two predetermined patterns are substantially identical to each other.

17. The apparatus, as in claim 15, wherein the second two predetermined patterns are substantially identical to each other.

18. The apparatus, as in claim 15, wherein the laser beam shifting means is further comprised of:
a dynamic shifting mirror.

19. The apparatus, as in claim 15, wherein the optical density comparison means is further comprised of:
an in-line densitometer.
